(19) United States
(12) Patent Application Publication
(10) Pub. No.: US 2023/0222415 A1
(43) Pub. Date: Jul. 13, 2023

(54) COMPUTER SYSTEMS AND METHODS FOR CREATING AND EXECUTING USER-CUSTOMIZED WORKFLOWS RELATED TO FINANCIAL ACCOUNTS

(71) Applicant: Discover Financial Services, Riverwoods, IL (US)

(72) Inventors: Rashim Parmar, Milford, CT (US); Santosh Reddy Kesireddy, Leander, TX (US); Jasleen Bedi, Chicago, IL (US); Antonio Gomez, London (GB)

(21) Appl. No.: 17/575,454

(22) Filed: Jan. 13, 2022

(51) Int. Cl. G06Q 10/06; G06Q 40/02

(52) U.S. Cl. CPC G06Q 10/06316; G06Q 40/02

(57) ABSTRACT

A computing platform may be installed with software technology for creating and executing user-customized workflows that configures the computing platform to: (1) cause a client station to present an interface for building a workflow, (2) receive data defining a given workflow that comprises (i) a user-defined set of information and (ii) a user-defined rule comprising (a) at least one condition and (b) at least one action that is to be carried out when the at least one condition is satisfied, (2) store the given workflow, (3) begin to execute the given workflow by iteratively: (i) obtaining a given snapshot of the user-defined set of information and (ii) applying the user-defined rule to the given snapshot to determine if the at least one condition is satisfied, and (4) when the at least one condition is satisfied, cause the at least one action to be carried out.

### BACKGROUND

Financial institutions may offer any of various kinds of financial accounts to their customers, examples of which may include checking accounts, savings accounts, credit cards, mortgages, and loans, among others.

Previously, customers of a financial institution would monitor and interact with their financial accounts by visiting a brick-and-mortar outpost of the financial institution, contacting the financial institution by telephone, and/or exchanging physical mail with the financial institution, which was often cumbersome and inefficient. However, most financial institutions today now operate computing platforms that enable customers to access, monitor, and interact with their financial accounts electronically over the Internet. In this respect, a financial institution's computing platform may host a variety of different software subsystems that each functions to provide a particular type of service related to a financial account associated with a customer via a network-accessible interface such as an application programming interface (API) that can be accessed by a computing device, such as the customer's computer, smartphone, or tablet (either directly or via an API gateway or the like).

### OVERVIEW

Disclosed herein is new software technology for creating and executing a user-customized workflow related to one or more financial accounts associated with a user.

In one aspect, the disclosed technology may take the form of a method to be carried out by a computing platform that involves (1) causing a client station associated with a user to present an interface that enables the user to build a workflow comprising (i) a user-defined set of information about one or more financial accounts associated with the user that is to be iteratively obtained and used as input for the workflow, and (ii) at least one user-defined rule that is to be iteratively applied to the user-defined set of information, wherein the at least one user-defined rule comprises (a) at least one condition that is to be evaluated based on the user-defined set of information and (b) at least one action that is to be carried out automatically by the computing platform when the at least one condition is determined to be satisfied, (2) receiving, from the client station, data defining a given workflow that has been built by the user via the interface and is to be automatically executed by the computing platform, and (3) storing a data representation of the given workflow in a workflow data store.

The user-defined set of information may take various forms, and in some example embodiments, may be based at least in part on information provided by one or more other network-accessible services hosted by the computing platform.

Further, the at least one action may take various forms, and in some example embodiments, may comprise an available action that is provided by at least one other network-accessible service hosted by the computing platform.

Further yet, the at least one condition may take various forms, and in some example embodiments, may comprise a given condition having at least a first predicate and a second predicate that are connected by a logical operator.

Still further, the data defining the given workflow may take various forms, and in some example embodiments, may comprise (i) data defining at least one given type of information that is to be iteratively obtained and used as input for the given workflow, (ii) data defining at least one given condition that is to be evaluated based on the given type of information, and (iii) data defining at least one given action that is to be carried out automatically by the computing platform when the given condition is determined to be satisfied. In this respect, as examples, the at least one given type of information may comprise one of (i) information about an account balance, (ii) information about one or more transactions, or (iii) information about one or more due payments, among other possibilities. Additionally, as examples, the at least one given condition may comprise one of (i) a threshold amount of money, (ii) a minimum balance amount, or (iii) an occurrence of a given type of transaction, among other possibilities. Additionally yet, as examples, the at least one given action may comprise one of (i) facilitating a funds transfer from a first financial account to a second financial account, (ii) issuing an alert to be provided to the user, or (iii) facilitating a payment from a financial account to a third party payee, among other possibilities.

In some example embodiments, the method may also further involve: (i) after receiving the data defining the given workflow and storing the data representation of the given workflow, causing the given workflow that has been built by the user to be presented to the user, (ii) while causing the given workflow to be presented to the user, receive data defining at least one modification to the given workflow, and (iii) updating the data representation of the given workflow stored in the workflow data store based on the data defining the at least one modification.

Further, in some example embodiments, the given workflow may comprise multiple user-defined rules that are to be iteratively applied to the user-defined set of information, where each of the multiple user-defined rules comprises (a) one respective condition that is to be evaluated based on at least a portion of the user-defined set of information and (b) one respective action that is to be carried out automatically by the computing platform when the one respective condition is determined to be satisfied.

In another aspect, the disclosed technology may take the form of a method to be carried out by a computing platform that involves (1) retrieving, from a workflow data store, a given workflow that has been previously built by a user and comprises: (i) a user-defined set of information about one or more financial accounts associated with the user that is to be iteratively obtained and used as input for the given workflow, and (ii) at least one user-defined rule that is to be iteratively applied to the user-defined set of information, wherein the at least one user-defined rule comprises (a) at least one condition that is to be evaluated based on the user-defined set of information and (b) at least one action that is to be carried out automatically by the computing platform when the at least one condition is determined to be satisfied, (2) beginning to execute the given workflow, wherein, while executing the given workflow, the computing platform functions to iteratively: (i) obtain a given snapshot of the user-defined set of information about the one or more financial accounts associated with the user and (ii) apply the at least one user-defined rule to the given snapshot of the user-defined set of information to determine if the at least one condition is satisfied, (3) while executing the given workflow, determining that the at least one condition is satisfied, and (4) in response to determining that the at least one condition is satisfied, causing the at least one action to be carried out.

The function of iteratively obtaining the given snapshot of the user-defined set of information about the one or more financial accounts associated with the user may take various forms, and in some example embodiments, may involve iteratively obtaining a given snapshot of information from one or more other network-accessible services hosted by the computing platform, which may either be used as the given snapshot of the user-defined set of information or may be used as a basis for deriving the given snapshot of the user-defined set of information.

Further, the function of causing the at least one action to be carried out may take various forms, and in some example embodiments, may involve causing at least one other network-accessible service hosted by the computing platform to carry out the at least one action.

Further yet, the user-defined set of information about the one or more financial accounts associated with the user may take various forms, and in some example embodiments, may include at least one of (i) an account balance, (ii) one or more transactions, or (iii) one or more due payments.

Still further, the at least one condition may take various forms, and in some example embodiments, may include at least one of (i) a threshold amount of money, (ii) a minimum balance amount, or (iii) an occurrence of a given type of transaction.

Further, the at least one corresponding action may take various forms, and in some example embodiments, may include at least one of (i) a funds transfer type of action, (ii) an alert type of action, or (iii) a payment type of action.

In some example embodiments, the given workflow may comprise multiple user-defined rules that are to be applied to the user-defined set of information, where each of the multiple user-defined rules comprises (a) one respective condition that is to be evaluated based on at least a portion of the user-defined set of information and (b) one respective action that is to be carried out automatically by the computing platform when the one respective condition is determined to be satisfied.

Further, in some example embodiments, the computing platform may function to iteratively obtain the given snapshot of the user-defined set of information and apply the at least one user-defined rule to the given snapshot in accordance with an iteration frequency, which could be defined based on configuration information included as part of the given workflow, among other possibilities.

In yet another aspect, disclosed herein is a computing platform that includes a network interface, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of one or both of the foregoing methods.

In still another aspect, disclosed herein is a non-transitory computer-readable medium provisioned with program instructions that, when executed by at least one processor, cause a computing platform to carry out the functions disclosed herein, including but not limited to the functions of one or both of the foregoing methods.

One of ordinary skill in the art will appreciate these as well as numerous other aspects in reading the following disclosure.

### BRIEF DESCRIPTION OF THE DRAWINGS

FIG. 1 depicts an example network configuration including an example computing platform operated by a financial institution.

FIG. 2 depicts an example network configuration including the example computing platform of FIG. 1 that has been configured to host an example software subsystem according to aspects of the disclosed technology.

FIG. 3 depicts example functional components of the example software subsystem of FIG. 2 that may be configured to carry out one or more of the functions according to aspects of the disclosed technology.

FIG. 4 depicts a flow diagram of an example process for creating a user-customized workflow according to aspects of the disclosed technology.

FIG. 5 depicts a flow diagram of an example process for executing a user-customized workflow according to aspects of the disclosed technology.

FIGS. 6A and 6B depict example illustrations demonstrating creation and execution of a user-customized workflow according to aspects of the disclosed technology.

FIG. 7 depicts example structural components of an example computing platform.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

As noted above, most financial institutions today operate computing platforms that enable customers to access, monitor, and interact with their financial accounts electronically over a data network such as the Internet. In this respect, a financial institution's computing platform may host a variety of different software subsystems that each functions to provide a certain type of service related to a financial account associated with a customer via a network-accessible interface such as an application programming interface (API) that can be accessed by the customer's computer, smartphone, tablet, or the like.

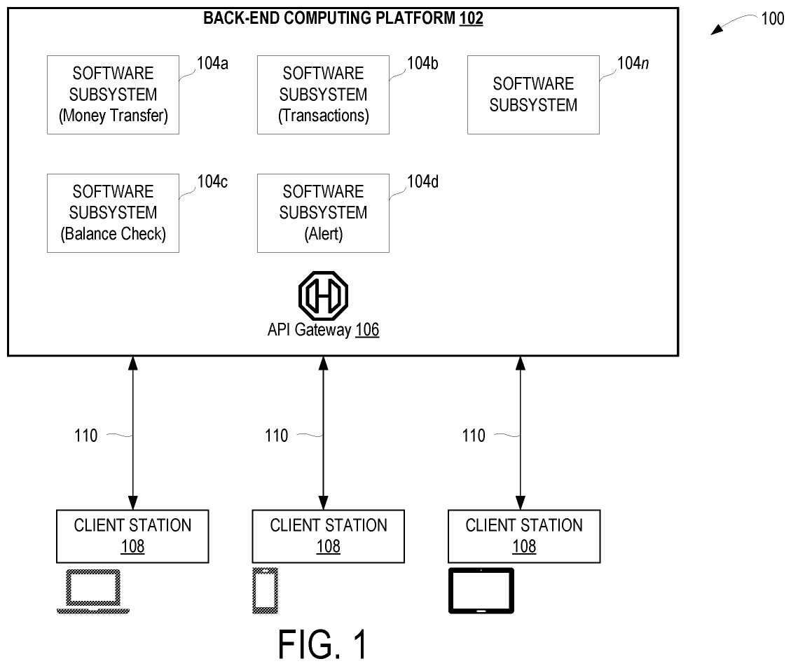

To illustrate with an example, FIG. 1 depicts a network configuration 100 that includes an example computing platform 102 operated by a financial institution along with three example client stations 108 that may each be configured to access and interact with the computing platform 102 on behalf of customers of the financial institution, who may also be referred to herein as “users” of the computing platform 102.

As shown in FIG. 1, the computing platform 102 may comprise a set of software subsystems 104 that may each function to provide a respective type of service to users via a network-accessible interface such as an API, as well as an API gateway 106 that may function to receive and process an API-based request incoming from a client station 108, route the API-based request to one or more appropriate software subsystems, and then return information associated with the API-based request to the client station 108.

These software subsystems 104—and the respective services provided by such software subsystems—may take any of various forms. Some representative examples of such software subsystems and associated services that may be provided by those software subsystems are shown in FIG. 1.

As one example, the computing platform 102 may include a first software subsystem 104a for providing a “Money Transfer” service that generally functions to facilitate a transfer of funds from one financial account to another financial account. The computing platform 102 may call upon, or run, the software subsystem 104a in order to provide the “Money Transfer” service to a given user. For example, the computing platform 102 may receive from a client station 108 via the API Gateway 106 a communication indicating a request on behalf of a user to transfer a given amount of funds from the user's checking account to the user's savings account. The API Gateway 106 may then route that request to the software subsystem 104a, which may in turn perform functions in order to carry out the request and cause the transfer to be executed.

As another example, the computing platform 102 may include a second software subsystem 104b for providing a “Transactions” service that generally functions to obtain and provide information about transactions that have occurred within a financial account. The computing platform 102 may run the software subsystem 104b in order to provide the “Transactions” service to a given user. For example, the computing platform 102 may receive from a client station 108 via the API Gateway 106 a communication indicating a request on behalf of a user to access information about all occurrences of a given type of transaction within a given time frame for a given financial account associated with the user. The API Gateway 106 may then route that request to the software subsystem 104b, which may in turn perform functions in order to carry out the request and return the information requested by the user so that it can be sent back to the client station 108.

As yet another example, the computing platform 102 may include a third software subsystem 104c for providing a “Balance Check” service that generally functions to obtain and provide account balance information for a financial account. The computing platform 102 may run the software subsystem 104c in order to provide the “Balance Check” service to a given user. For example, the computing platform 102 may receive from a client station 108 via the API Gateway 106 a communication indicating a request on behalf of a user to receive information about a current account balance and/or an account balance history for a given financial account. The API Gateway 106 may then route that request to the software subsystem 104c, which may in turn perform functions in order to carry out the request and return the requested account balance information for the given financial account so that it can be sent back to the client station 108.

As still another example, the computing platform 102 may include a fourth software subsystem 104d for providing an “Alerts” service that generally functions to generate and issue an alert to a user regarding an activity related to a financial account. The computing platform 102 may run the software subsystem 104d in order to provide the “Alerts” service to a given user. For example, the computing platform 102 may receive from a client station 108 via the API Gateway 106 a communication indicating a request on behalf of a user to receive an alert when a given activity within a given financial account occurs. The API Gateway 106 may then route that request to the software subsystem 104d, which may in turn perform functions in order to carry out the request and issue an alert to the user when the given activity within the given financial account occurs.

In practice, each of the computing platform's software subsystems 104 may also interact with one or more other software subsystems as part of the software subsystem's functionality for providing a given respective service to a user. For example, the first software subsystem 104a for providing a “Money Transfer” service may interact with one or more other software subsystems in order to cause a transfer of funds to be executed. Many other examples are possible as well.

Each of the foregoing software subsystems 104 hosted by the computing platform 102 may also have a respective network-accessible interface—such as an API, an Inter-process communication (IPC) interface, or the like—that allows the software subsystem 104 to be accessed over a data network by other software subsystems either directly or via the API gateway 106 (e.g., software subsystems running at the computing platform 102 and/or software subsystems running on client stations 108).

As illustrated in FIG. 1 by the software subsystem 104n, the computing platform 102 may also host other software subsystems for providing other types of account-related services not shown in FIG. 1. For example, although not shown, the computing platform 102 may include a software subsystem for providing a service that involves interaction with a computing system that is external to the computing platform 102 (e.g., via an API of the external computing system). Other examples are possible.

In practice, the software subsystems that are hosted by the computing platform 102 to deliver services provided by the financial institution to users may be implemented using any of a variety of software architecture styles and/or deployment patterns. As examples, the software subsystems that are hosted by the computing platform 102 may be implemented using a microservices architecture, a service-oriented architecture, and/or a serverless architecture, among various other possibilities, along with a container-based deployment pattern, a virtual-machine-based deployment pattern, and/or a Lambda-function-based deployment pattern, among other possibilities.

Further, in practice, the computing platform 102 may generally comprise some set of physical computing resources (e.g., processors, data storage, etc.) that are configured to run the software subsystems discussed herein, among various other software subsystems that may be hosted and run by computing platform 102. This set of physical computing resources take any of various forms. As one possibility, the computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the computing platform 102 may comprise “on-premises” computing resources of the financial institution that operates the example computing platform 102 (e.g., institution-owned servers). As yet another possibility, the example computing platform 102 may comprise a combination of cloud computing resources and on-premises computing resources. Other implementations of the computing platform 102 are possible as well.

As noted above, the example network environment 100 may also include three example client stations 108 that may be utilized by customers of the financial institution to access and interact with the computing platform 102. In this respect, each client station 108 may include hardware components such as a processor, data storage, a communication interface, and user-interface components (or interfaces for connecting thereto), among other possible hardware components, as well as software that facilitates the client station's ability to interact with the computing platform 102 in order to access the services hosted by the computing platform 102 (e.g., operating system software, web browser software, a mobile application, etc.). As representative examples, each client station 108 may take the form of a computing device such as a desktop computer, a laptop, a netbook, a tablet, a smartphone, or a personal digital assistant (PDA), among other possibilities.

As further shown in FIG. 1, the computing platform 102 may be configured to interact with the client stations 108 over respective network-based communication paths 110. In this respect, each respective communication path 110 between the computing platform 102 and a client station 108 may generally comprise one or more communication networks and/or communications links, which may take any of various forms. For instance, each respective communication path 110 may include any one or more of point-to-point links, Personal Area Networks (PANs), Local-Area Networks (LANs), Wide-Area Networks (WANs) such as the Internet or cellular networks, and/or cloud networks, among other possibilities. Further, the communication networks and/or links that make up each respective communication path 110 may be wireless, wired, or some combination thereof, and may carry data according to any of various different communication protocols. Although not shown, the respective communication paths 110 between the client stations 108 and the computing platform 102 may also include one or more intermediate systems. For example, it is possible that the computing platform 102 may communicate with a given client station 108 via one or more intermediary systems, such as a host server (not shown). Many other configurations are also possible.

It should be understood that network configuration 100 is one example of a network configuration in which embodiments described herein may be implemented. Numerous other arrangements are possible and contemplated herein. For instance, other network configurations may include additional components not pictured and/or more or less of the pictured components.

In most cases, the software subsystems and associated services hosted by a financial institution's computing platform, such as the computing platform 102, enable users to perform tasks related to their financial accounts only in an “on demand” manner. As one example, a user may wish to be informed on a periodic basis about a current balance for a given financial account. To get that information, the user must access the computing platform 102 and request the current balance for the given financial account each time the user wishes to obtain that information. As another example, the user may wish to be informed on a regular basis about up-to-date transactions within a given financial account. To get that information, the user must regularly access the computing platform 102 and request information about transactions that have recently occurred within the given financial account.

However, in some limited circumstances, the services that are provided by a financial institution's computing platform, such as the computing platform 102, may allow users to schedule tasks that are to be carried out automatically by the computing platform. For example, a user may be able to schedule a transfer from one account to another account that is to be carried out automatically by the computing platform on a given date or schedule a payment to a given payee that is to be carried out automatically by the computing platform on a given date.

In this respect, the existing technology for configuring such automated tasks is simplistic and offers very limited customizability of these automated tasks. For instance, existing technology for configuring automated tasks does not allow users to create their own user-customized tasks and instead typically requires a user to select from a set of available tasks that have been predefined by the financial institution. Thus, the scope of automated tasks that the user may schedule is restricted by the set of tasks that have been predefined by the financial institution. Tasks that fall outside of that limited scope may be unable to be automated and may instead need to be performed by the user manually or on an “on demand” basis as described above.

Further, given that existing technology limits a user to selecting from some limited set of predefined options for scheduled an automated task, such existing technology provides no ability for a user to build user-customized workflows for automating tasks—let alone user-customized workflows that automate tasks by applying user-customized rules to user-customized sets of account-related information for the user. For example, while existing technology may allow a user to schedule an automated transfer of a set amount to take place on a set date, existing technology provides no ability for a user to build a user-customized workflow for automating a transfer that iteratively applies a user-customized rule to a user-customized set of account-related information in order to dynamically determine whether to execute a transfer and/or what amount to transfer. Similar limitations exist with respect to other existing services that allow users to configure automated tasks.

Further yet, to the extent that the capability to configure automated tasks is even provided by a computing platform, there is no existing technology that provides a service that enables a user to configure multiple different types of automated tasks via a single, unified user interface. Instead, each service of the computing platform that allows configuration of automated tasks has its own service-specific user interface that must be accessed by a user in order to configure an automated task associated with that service, which requires a user to navigate to and access multiple different service-specific interface in order to configure different types of automated tasks. For instance, consider a computing platform that is configured to host both a first service that allows a user to schedule an automated transfer and a second service that allows a user to schedule an automated payment. In order to take advantage of both of these services, the user will have to access a first user interface specific to the first service in order to schedule a desired automated transfer and will then have to separately access a second interface specific to the second service in order to schedule a desired automated payment. Therefore, in addition to being significantly constrained by the predefined options offered by the computing platform, the existing technology for scheduling automated tasks provides a subpar user experience that can be cumbersome and time consuming. In fact, given the siloed nature of existing technology for scheduled different types of automated tasks, a user may not even be aware that certain types of tasks can be automated unless the user has previously scheduled an automated task of that type or happens to come across the respective interface for scheduling an automated task of that type.

To address these and other problems, disclosed herein is new software technology that allows for the creation and execution of user-customized workflows that automate actions related to one or more financial accounts associated with a user by applying user-defined rules to user-defined sets of information about the one or more financial accounts. In this way, the disclosed technology enables customers of a financial institution to interact with their financial accounts in a more targeted and personalized way.

In practice, the software technology disclosed herein may be implemented as a new software subsystem that is hosted by a computing platform operated by a financial institution, such as the computing platform 102 of FIG. 1. At a high level, this new software subsystem may provide a new service that enables a user to build a user-customized workflow related to one or more financial accounts associated with the user (which may leverage other services provided by the computing platform) and then deploys the user-defined workflow for automatic execution by the computing platform, which may involve (i) automatically evaluating whether some user-defined condition related to the one or more financial accounts associated with the user is satisfied and then (ii) automatically carrying out one or more actions related to the one or more financial accounts associated with the user (e.g., by calling one or more other services provided by the computing platform).

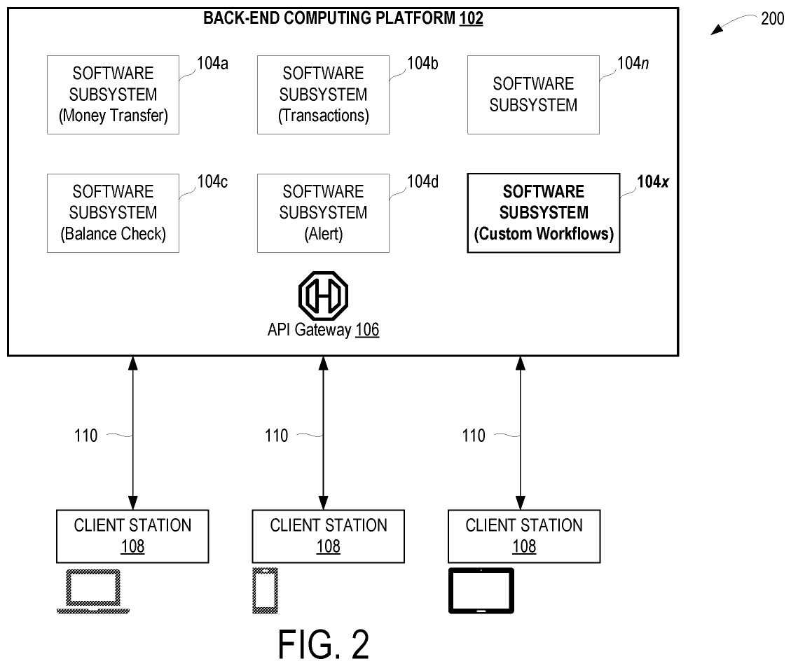

One possible example of such a software subsystem is illustrated in the context of FIG. 2, which shows an updated version 200 of the network configuration 100 shown in FIG. 1 in which the computing platform 102 has been configured to host a new software subsystem 104x for creating, storing, and automatically executing user-customized workflows. This new software subsystem 104x may be referred to herein as a “custom workflows software subsystem” or “CW software subsystem.” As with the other software subsystems 104 described above, the new CW software subsystem 104x may also comprise a network-accessible interface such as an API that can be accessed by a client station 108 associated with a user (either directly via a respective communication path 110 or via the API gateway 106).

The user-customized workflows that may be created and executed in accordance with the present disclosure may take various forms, but in general, each such user-customized workflow may comprise (i) a user-defined set of information about one or more financial accounts associated with the user that is to serve as input for the user-customized workflow, which may be based at least in part on information provided by one or more other software subsystems hosted by the computing platform 102 and (ii) at least one user-defined rule that is to be applied to the user-defined set of information, which includes (a) at least one user-defined condition that is to be evaluated based on the user-defined set of information and (b) at least one corresponding action that is to be carried out automatically by the computing platform if the at least one user-defined condition is satisfied.

In general, the user-defined set of information about the one or more financial accounts associated with the user (which may be referred to herein as “input information” for the user-customized workflow) may comprise any information about a financial account associated with a user that can be evaluated by a user-defined rule (either alone or in combination with other information) in order to determine whether to carry out an action related to a financial account associated with the user (which may either be the same as or different than the financial account to which the input information relates). This information may take various forms.

As a first possibility, the user-defined set of information about the one or more financial accounts associated with the user may comprise information about an account balance of a financial account associated with the user. As a second possibility, the user-defined set of information about the one or more financial accounts associated with the user may comprise information about one or more transactions within a financial account, such as an occurrence of a credit, a debit, a purchase, a withdrawal, a deposit, a refund, a transfer, or a payment, among other possibilities. In this regard, as one example, the information about transactions within a financial account may take the form of transaction-level details about transactions within a financial account during some period of time, which could be for all transactions during that period or may be specifically for transactions of a particular type, among other possibilities. As another example, the information about transactions within a financial account may take the form of summary information about transactions within a financial account during some period of time, such as a total or net amount of spend during some period of time or a total amount of a particular type of transaction (e.g., withdrawals, deposits, purchases, etc.) during some period of time, among other examples. As a third possibility, the user-defined set of information about the one or more financial accounts associated with the user may comprise information regarding a credit score for the user. As a fourth possibility, the user-defined set of information about the one or more financial accounts associated with the user may comprise information regarding upcoming payments due for a financial account associated with a user (e.g., a mortgage payment, a bill payment, etc.). The user-defined set of information about the one or more financial accounts associated with the user may take various other forms as well.

In practice, when defining the set of information about the one or more financial accounts associated with the user that is to serve as input for the user-customized workflow, the user may specify the type of information along with certain configuration information that serves to further define the set of information that is to serve as input for the user-customized workflow. This configuration information may take various forms, which may depend in part on the type of information that is specified. As one example, such configuration information may include an identifier of a particular financial account for which information is to be obtained (e.g., one of the financial accounts to which the user has access). As another example, such configuration information may include an indication of a particular transaction type for which information is to be obtained. As yet another example, such configuration information may include an identifier of a particular period of time for which information is to be obtained (e.g., over the course of a calendar month). Other examples are possible as well.

As noted above, the set of information defined by the user for the user-customized workflow may be based at least in part on information provided by one or more other software subsystems of the computing platform 102. In this respect, certain types of information defined by a user may be provided directly by another software subsystem hosted by the computing platform 102, while other types of information defined by a user may involve additional calculation(s) by custom workflows software subsystem 104x based on the information provided by one or more other software subsystems of the computing platform 102. For example, if the user-defined set of information comprises a balance amount for a financial account, such information may be provided directly by the third software subsystem 104c, whereas if the user-defined set of information comprises total or net spend for a financial account during a given period of time, such information may need to be calculated by custom workflows software subsystem 104x based on transactions information provided by one or more other software subsystems (e.g., the second software subsystem). Many other examples are well.

Turning to the at least one user-defined condition that is to be evaluated based on the user-defined set of information, in general, each such condition may take the form of a logical expression that can be evaluated either as true (e.g., the condition is satisfied) or false (e.g., the condition is not satisfied), where that expression may comprise either a single predicate or a sequence of multiple predicates connected by one or more logical operators (e.g., “or,” “and,” “not,” “and not,” etc.). In this respect, the condition may be thought of as the “if” portion of an “if-then” conditional statement, while the at least one corresponding action may be thought of as the “then” portion of the “if-then” conditional statement. Such a predicate may take any of various forms.

As a first possibility, a predicate may comprise a threshold amount of money that is to be compared to some amount of money that is included as part of the input information. This threshold amount of money may take various forms. As one example, the threshold amount of money may comprise a maximum spending limit or some percentage thereof (e.g., 70%, 80%, etc.) for some period of time. As another example, the threshold amount of money may comprise a minimum balance amount. Many other examples are possible as well. As a second possibility, a predicate may comprise an occurrence of a given type of transaction or a threshold number of occurrences of a given type of transaction during some period of time. A predicate may take any of various other forms as well.

In practice, when defining the at least one condition for the user-customized workflow, the user may specify each type of predicate (and perhaps also each logical operator that connects the predicates) along with certain configuration information that serves to further define the at least one condition for the user-customized workflow. This configuration information may take various forms, which may depend in part on the type of predicate(s) that are specified. As one example, the configuration information may comprise an amount of a threshold or a type of transaction. As another example, the configuration information may comprise time and/or frequency information that applies to a given predicate or to the condition as a whole (e.g., that the condition is to be applied on a monthly basis to information within each calendar month). Other examples are possible as well.

Turning next to the at least one corresponding action that is to be carried out automatically by the computing platform if the condition is satisfied in general, this may comprise any possible action that can be performed by the computing platform 102 with respect to one or more financial accounts of the user. Examples of such an actions may include facilitating a funds transfer from a first financial account to a second financial account, issuing an alert to be provided to the user, facilitating a payment from a financial account to a third party (e.g., a utility provider, a bill payee), and generating a report to be provided to the user, among other possibilities.

In practice, when defining the at least one action for the user-customized workflow, the user may specify the type of action along with certain configuration information that serves to further define the at least one action for the user-customized workflow. This configuration information may take various forms, which may depend on the type of action that is specified. As one example, configuration information for a funds transfer type of action may comprise information defining what amount of money is to be transferred between accounts. As another example, configuration information for an alert type of action may comprise information defining the manner in which an alert or report is to be delivered to a user (e.g., email, text, etc.). As yet another example, configuration information for a payment type of action may comprise information identifying a third party that is to be paid and/or an amount that is to be paid. Many other examples are possible as well.

In accordance with the present disclosure, the user-defined set of information, the at least one user-defined condition, and the at least one corresponding action may be combined together by a user in any of various manners in order to create a new user-customized workflow. At a high level, such a user-customized workflow may include either one type of input information or multiple types of input information, one condition or multiple separate conditions (where each such condition includes a single predicate or multiple predicates), and one corresponding action for a condition or multiple corresponding actions for a condition. For instance, as one possibility, a user-customized workflow may comprise a single type of input information, a condition that includes a single predicate, and a single corresponding action. As another possibility, a user-customized workflow may comprise more than one type of input information, a single condition that includes more than one predicate, and a single corresponding action. As yet another possibility, a user-customized workflow may comprise more than one type of input information, a single condition that includes more than one predicate, and more than one corresponding action. Still, as another possibility, a user-customized workflow may comprise one or more types of input information, more than one condition, and a corresponding action for each condition. Numerous other possibilities exist.

To illustrate, one example of a user-customized workflow that may be created as described above may be a workflow for automatically transferring funds from a first account (e.g., a checking account) to a second account (e.g., a savings account) based on a user's monthly expenditures. For such a workflow, the user-defined set of information about one or more financial accounts associated with the user—or the input information—may include (i) an account balance of the first account and (ii) transaction-level details about transactions within the first account. The configuration information that serves to further define that input information may include (i) an identifier of the first account and (ii) an indication of one or more particular types of transaction (e.g., credit, withdrawal, purchase, and/or payment) for which transaction-level details are to be obtained. Further, the user-customized workflow may include a condition having a first predicate that comprises a maximum spending limit and a second predicate that comprises a minimum balance amount, wherein the first and second predicates are connected with an “AND” logical operator. The configuration information that serves to further define the condition may include (i) an amount for the maximum spending limit, (ii) an amount for the minimum account balance, (iii) a period of time during which the condition is to be evaluated (e.g., a calendar month), and (iv) a frequency at which the condition is to be evaluated (e.g., monthly). Further, the user-customized workflow may include a corresponding action comprising a transfer of funds. The configuration information for the corresponding action may include (i) an amount that is to be transferred and (ii) an identifier of the second account. Together, the input information, the condition, and the corresponding action at effectively form a rule (e.g., a conditional statement) that indicates: at the end of each month, IF the maximum spending limit for the checking account has not been reached AND a minimum account balance remains in the savings account, THEN a given amount of funds is to be transferred from the checking account to the savings account.

As another example of a user-customized workflow that may be created as described above may be a workflow for automatically generating alerts based on account activity. For such a workflow, the user-defined set of information about the financial account associated with the user—or the input information—may include (i) an account balance of the financial account and (ii) transaction-level details about transactions within the financial account. The configuration information that serves to further define that input information may include (i) an identifier of a given financial account and (ii) an indication of one or more particular types of transaction (e.g., all transaction occurrences) for which transaction-level details are to be obtained. Further, the user-customized workflow may include a condition having a first predicate that comprises a threshold amount and a second predicate that comprises a minimum balance amount. The configuration information for that condition may include (i) a first threshold percentage (e.g., 70%), (ii) a second threshold percentage (e.g., 80%), and (iii) a third threshold percentage (e.g., 90%). Further, the user-customized workflow may include a corresponding action comprising issuing an alert that is provided to the user. The configuration information for the corresponding action may include (i) a preferred method of contact and (ii) contact information. Together, the input information, the condition, and the corresponding action at effectively form a rule (e.g., a conditional statement) that indicates: IF a threshold amount of the minimum balance account is reached, THEN an alert is to be issued to the user.

The preceding examples demonstrate merely two specific ways that user-defined information, at least one user-defined condition, and at least one corresponding action may be used to create a user-customized workflow as described herein. It should be understood that many other ways of combining user-defined information, a condition(s), and a corresponding action(s) are possible. For instance, in either one of the preceding example workflows, one or more predicates may be added to each condition, one or more additional conditions may be added, and/or one or more additional corresponding actions may be added. Additionally, the user-defined information, condition, and corresponding action included in the two workflows described above may be combined into a single workflow. Many other examples are possible.

A user-customized workflow that is created and executed in accordance with the present disclosure may take various other forms as well.

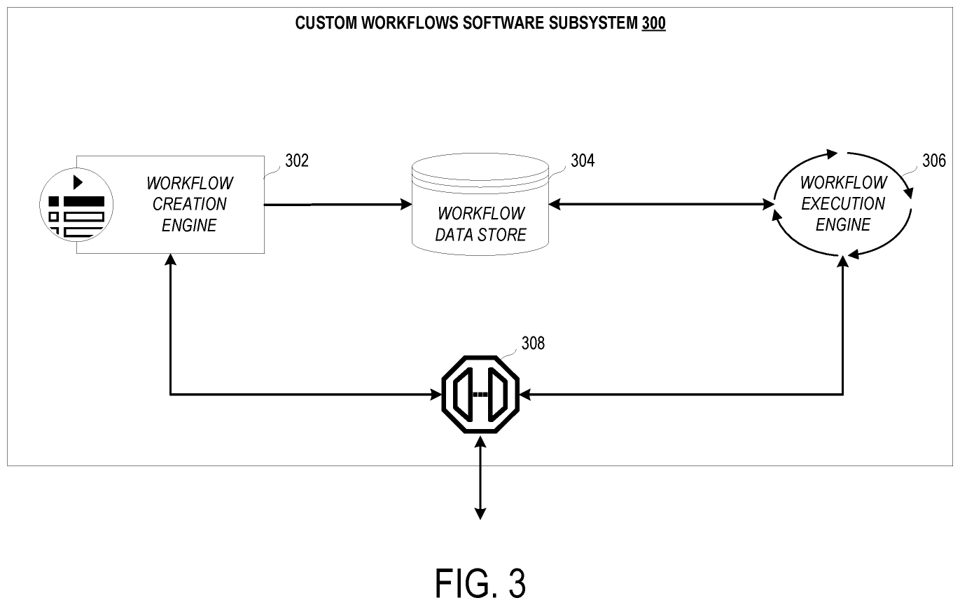

Turning now FIG. 3, one possible example of a custom workflows software subsystem 104x shown of FIG. 1 is illustrated, which is shown in FIG. 3 as custom workflows software subsystem 300. As shown in FIG. 3, this custom workflows software subsystem 300 may comprise a workflow creation engine 302, a workflow data store 304, a workflow execution engine 306, and a network-accessible interface 308, among other possible components. In line with the discussion above, it should be understood that these components of the custom workflows software subsystem 300 may be implemented using a microservices architecture, a services-oriented architecture, and/or a serverless architecture, among other possibilities.

In general, the workflow creation engine 302 may be configured to perform functions that facilitate creation of a user-customized workflow, examples of which may include (i) causing a client station 108 associated with a user to present an interface for building such a workflow via the network-accessible interface 308, (ii) receiving, from the client station 108 via the network-accessible interface 308, data defining a given workflow that has been built by the user, and (iii) storing, in the workflow data store 304, a data representation of the given workflow.

Further, in general, the workflow execution engine 306 may be configured to perform functions that facilitate execution of a user-customized workflow, examples of which may include (i) retrieving a given user-customized workflow that is stored in the workflow data store 304, (ii) beginning to execute the given user-customized workflow, which may involve iteratively performing functions of (a) obtaining a given snapshot of the user-defined set of information about one or more financial accounts (which may involve either obtaining a new snapshot or obtaining a prior snapshot has been stored for future access) and (b) applying the user-defined rule included in the user-customized workflow to the given snapshot of the user-defined set of information to determine whether at least one user-defined condition is satisfied and at least one corresponding action is to be carried out, and then (iii) while executing the given user-customized workflow, carrying out the at least one corresponding action each time an iteration results in a determination that the condition is satisfied (which may involve requesting at least one other software subsystem to perform an action related to the one or more financial accounts).

However, it should be understood that workflow creation engine 302 and workflow execution engine 306 may perform various other functions as well.

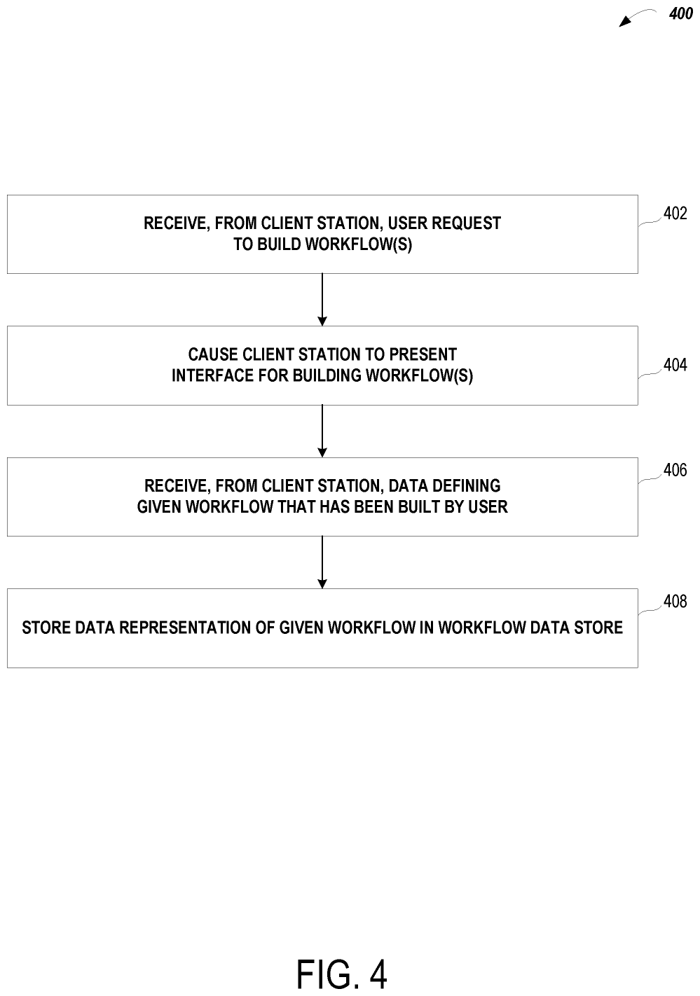

Turning now to FIG. 4, a flow diagram of an example process 400 that may be carried out by the custom workflows software subsystem disclosed herein in order to facilitate creation of a user-customized workflow is depicted. For purposes of illustration only, example process 400 is described as being carried out by the custom workflows software subsystem 300 of FIG. 3, but it should be understood that example process 400 may be carried out by one or more software subsystems that take other forms as well. Further, it should be understood that, in practice, these functions of the custom workflows software subsystem 300 may be encoded in the form of program instructions that are executable by one or more processors of the computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

As shown in FIG. 4, the example process 400 may begin at 402 with the custom workflows software subsystem 300 receiving an indication of a user request to create a customized workflow. For instance, a user may direct a client station 108 to access the “Custom Workflows” service provided by the custom workflows software subsystem 300 by opening a software application that facilitates interaction with the computing platform 102 (e.g., an operating system software, a web browser software, a mobile application, etc.) and navigating to a view for creating a customized workflow.

In turn, at block 404, the custom workflows software subsystem 300 may cause the client station 108 to present the user interface for creating a user-customized workflow (e.g., by transmitting one or more instruction messages to the client station 108). In line with the discussion above, such a user-customized workflow may comprise (i) a user-defined set of information about one or more financial accounts associated with the user and (ii) at least one user-defined rule that is to be applied to the user-defined set of information, which includes (a) at least one user-defined condition that is to be evaluated based on the user-defined set of information and (b) at least one corresponding action that is to be carried out automatically by the computing platform if the at least one user-defined condition is satisfied.

In general, the user interface may serve to guide the user through a process of building a new user-customized workflow, which may involve (i) defining a set of information about one or more financial accounts associated with the user that is to serve as input for the new user-customized workflow, and (ii) defining at least one rule that comprises (a) at least one user-defined condition that is to be evaluated based on the user-defined set of information, and (b) at least one corresponding action that is to be carried out automatically by the computing platform if the at least one user-defined condition is satisfied.

In order to facilitate the user's task of defining the set of information that is to serve as input for the new user-customized workflow, the user interface may include a view that (i) presents a list of available types of information that may be obtained about one or more financial accounts associated with the user and (ii) enables the user to select one or more of the types of information that are to serve as input for the new user-customized workflow. In line with the discussion above, these available types of information that are presented as options to the user may take various forms, examples of which may include information about an account balance of a financial account, information about transactions within a financial account (e.g., transaction-level and/or summary information about occurrences of one or more specific types of transactions), information regarding a credit score, and/or information regarding upcoming payments that are due (e.g., a mortgage payment, a bill payment, etc.), among other possibilities.

In practice, the list of available types of information may be presented to the user for selection in various ways. As one example, the list of available types of information may be presented to the user in the form of a drop-down list from which one or more of the available types of information may be selected. As another example, the list of available types of information may be presented to the user in the form of a list of selectable tiles corresponding to the types of information that can each be dragged and dropped into a selection panel. The list of available types of information may be presented to the user for selection in other manners as well.

After receiving an indication that at least one type of information has been selected, the client station 108 may present via the user interface one or more options that then enable the user to input configuration information pertaining to the one or more types of information. Such configuration information may include, as some nonlimiting examples, an identifier of a particular financial account for which information is to be obtained (e.g., one of the financial accounts to which the user has access), an indication of a particular transaction type for which information is to be obtained, and/or an identifier of a particular period of time for which information is to be obtained (e.g., over the course of a calendar month).

After the user has finished defining the set of information that is to serve as input for the user-customized workflow, the user interface may then provide one or more views for guiding the user through the process of creating at least one user-defined rule for the user-customized workflow. At that time, the user interface may no longer include the view for defining the set of input information but may include an option for the user to return to that view if needed by selecting an interface button to do so, such as a “Back” interface button or a “Select Information” interface button. Alternatively, the user interface may continue to include a view for defining the set of input information, such as a miniaturized version of the view for defining the set of input information that can be expanded upon selection.

Further, in order to facilitate the user's task of defining at least one rule for the new user-customized workflow, the user interface may include a view that enables the user to define one or more conditions that are to be applied to the user-defined set of information. In this respect, as noted above, such a condition may generally take the form of a logical expression that can be evaluated either as true (e.g., the condition is satisfied) or false (e.g., the condition is not satisfied), where that expression may comprise either a single predicate or a sequence of multiple predicates connected by one or more logical operators (e.g., “or,” “and,” “not,” “and not,” etc.).

As such, the user interface may enable the user to define the one or more predicates that are to be include in the condition, and if the condition is to include two or more predicates, the user interface may also enable the user to define the one or more logical operators that connects the two or more predicates. As noted above, these predicates may take any of various forms, examples of which may include a threshold amount of money (e.g., a maximum spending limit during some period of time or a threshold percentage thereof, a minimum balance amount, etc.), or an occurrence of a given type of transaction or a threshold number of occurrences of a given type of transaction, as some non-limiting possibilities.

The user interface may also enable the user to input configuration information pertaining to the condition, which may include an amount of a threshold, a type of transaction, and/or time or frequency information that applies a given predicate or to the condition as a whole (e.g., that the condition is to be applied on a monthly basis to information within each calendar month), as some nonlimiting examples.

Further yet, in order to facilitate the user's task of defining at least one rule for the new user-customized workflow, the user interface may include a view that (i) presents a list of one or more available actions that may be carried out by the computing platform 102 and (ii) enables the user to select one or more of the actions to add to the new user-customized workflow. In line with the discussion above, the one or more actions presented as options to the user may include, as some non-limiting possibilities, implementing a funds transfer from a first financial account to a second financial account, issuing an alert to be provided to the user, implementing a payment from a financial account to a third party (e.g., a utility provider, a bill payee), and generating a report to be provided to the user.

In practice, the list of available actions may be presented to the user for selection in various ways. As one example, the list of available actions may be presented to the user in the form of a drop-down list from which one or more of the available actions may be selected. As another example, the list of available actions may be presented to the user in the form of a list of selectable tiles corresponding to the actions that can each be dragged and dropped into a selection panel. The list of available actions may be presented to the user for selection in other manners as well.

After receiving a user's selection of the at least one action, the user interface may enable the user to input configuration information for the at least one action. Such configuration information may include, as some non-limiting examples, information defining what amount of money is to be transferred between accounts, information defining the manner in which an alert or report is to be delivered to a user (e.g., email, text, etc.), and/or information identifying a third party that is to be paid.

In some implementations, the user interface may also enable the user to add more than one rule to a user-customized workflow. In such instances where multiple rules are added to the workflow, the user interface may enable the user to arrange the rules in a desired sequence within the workflow, thereby dictating an order in which each rule is to be evaluated. For example, the user interface may enable dragging-and-dropping of each rule to form a desired sequence. Alternatively, the user interface may enable a numbered entry for each rule that indicates that rule's order in a desired sequence. Other examples are also possible. In this way, the custom workflows software subsystem 300 enables the user to layer rules within a workflow in a way that indicates different timings that dictate when each of one or more automated actions is to be performed by the computing platform 102.

After a user has finished providing inputs for the new user-customized workflow, the user may select an option within the user interface indicating that the user has finished building the new user-customized workflow and wishes to “save” that workflow. After the client station 108 has received the indication that the user has finished building the user-customized workflow, the client station 108 may transmit data that defines the user-customized workflow built by the user to the computing platform 102.

At block 406 of FIG. 4, the custom workflows software subsystem 300 may then receive from the client station 108 the data defining the user-customized workflow that has been built by the user. In practice, this data defining the user-customized workflow may initially be received by the API gateway 106 of the computing platform 102, and may then be routed from the API gateway 106 to the custom workflows software subsystem 300. However, other examples are possible as well.

In turn, at block 408, the custom workflows software subsystem 300 of the computing platform 102 may store a data representation of the user-customized workflow into the workflow data store 304. In practice, this data representation of the user-customized workflow may take any of various forms, one example of which may be a data record for storage within a relationship database.

The process that may be carried out by the custom workflows software subsystem disclosed herein in order to facilitate creation of a user-customized workflow may take other forms as well.

After the custom workflows software subsystem 300 has caused the representation of the user-customized workflow to be stored in the workflow data store 304, it may cause the client station 108 to present a user interface view that includes a visualization of the user-customized workflow. The user interface may enable the user to take one or more actions with respect to the user-customized workflow, such as modifying the user-customized workflow. Additionally, or alternatively, the user interface may enable the user to take one or more such actions at a later time.

In general, the custom workflows software subsystem 300 may, at any time after a given workflow has been created and stored, receive an indication of a user request to access to a previously-created given workflow. For instance, a user (which may or may not be the same as the user who created the original given workflow) may direct a client station (which may be different from a client station that was accessed at the time of creating the workflow) to access the custom workflows software subsystem 300. The user may then navigate to an interface view for viewing and/or modifying the given workflow. In turn, the computing platform may cause the user's client station to present an interface view that includes a visualization of the given workflow. Additionally, the view may include one or more options that enable the user to modify the given workflow. For example, the view may include options to modify the user-defined set of information, the configuration information, one or more conditions, and/or one or more corresponding actions that are included in the given workflow. The options to modify the given workflow may include options to edit, re-arrange, add, and/or remove one or more components of the workflow, as well as an option to delete the given workflow, and may be presented to the user in various ways, including the ways described above with respect to the workflow creation engine 302 presenting one or more interface views for creating a user-customized workflow.

After receiving an indication that the user has completed inputting one or more modifications to the given workflow, the client station may send data defining the one or more modifications to the custom workflows software subsystem 300. The custom workflows software subsystem 300 may then cause the data defining the one or more modifications to be stored in the workflow data store 304. In this regard, the data defining the one or more modifications may update or replace data defining the original given workflow.

Further, the custom workflows software subsystem 300 may cause the workflow execution engine 306 to be notified that the original given workflow has been modified and thus stop executing the original given workflow and begin executing the modified given workflow instead. For example, the workflow execution engine 306 may be notified that the original given workflow has been modified by receiving a communication from the workflow creation engine 302 or by determining that the original given workflow has been modified when attempting to retrieve it during an iteration of executing the original given workflow. In turn, the workflow execution engine 306 may stop executing the original given workflow and may begin executing the modified given workflow.

Still further, the custom workflows software subsystem 300 may, at any time after a given workflow has been created and stored, receive an indication of a user request to access information about the status of a previously-created given workflow. For instance, a user (which may or may not be the same as the user who created the original given workflow) may direct a client station (which may be different from a client station that was accessed at the time of creating the workflow) to access the service provided by the custom workflows software subsystem 300. The user may then navigate to an interface view for viewing a status of the given workflow. In turn, the computing platform may cause the user's client station to present one or more interface views that include information about the status of the given workflow.

In general, information about the status of a previously-created workflow may take any of various forms, examples of which may include information about when the workflow was first executed, information about how many iterations of the workflow have been performed, historical information about each iteration where a rule included in the workflow was satisfied, and a current state of each rule in the workflow (e.g., if in a most-recent iteration, the rule was determined to be “satisfied” or “not satisfied”), among other possibilities. In order to facilitate this functionality, the workflow execution engine 306 may be configured to store status information about the execution of the previously-created workflow in the workflow data store 304 (as will be described in more detail further below), and the custom workflows software subsystem 300 may then be configured to obtain such status information from the workflow data store 304 when a request to access that information is received.

The process that may be carried out by the custom workflow software subsystem disclosed herein in order to facilitate creation of a user-customized workflow may take various other forms as well.

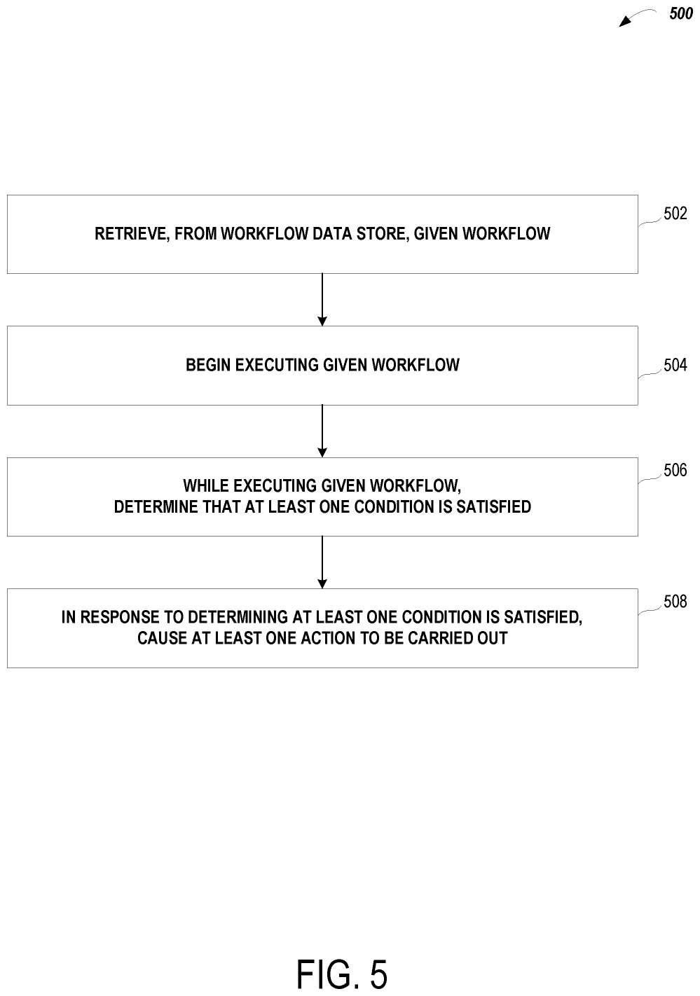

Turning now to FIG. 5, a flow diagram of an example process 500 that may be carried out by the custom workflows software subsystem disclosed herein in order to execute a user-customized workflow is depicted. For purposes of illustration only, example process 500 is described as being carried out by the custom workflows software subsystem 300 of FIG. 3, but it should be understood that example process 500 may be carried out by one or more software subsystems that take other forms as well. Further, it should be understood that, in practice, these functions of the custom workflows software subsystem 300 may be encoded in the form of program instructions that are executable by one or more processors of the computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

As shown in FIG. 5, the example process 500 may begin at 502 with the workflow execution engine 306 retrieving a given user-customized workflow from the workflow data store 304 (e.g., by accessing the stored data representation of the user-customized workflow) in order to facilitate execution of the given user-customized workflow. In practice, the workflow execution engine 306 may perform this function in response to determining that the given user-customized workflow has been newly created and is available for execution (e.g., by detecting a new entry in the workflow data store 304 or receiving a communication from the custom workflow creation engine 302 indicating that the given user-customized workflow has been created), although the workflow execution engine 306 may execute the given workflow at other times and/or in response to other triggers as well.

In line with the discussion above, the given user-customized workflow that is retrieved from the workflow data store may comprise (i) a user-defined set of information about one or more financial accounts associated with the user that is to serve as input for the user-customized workflow, which may be based at least in part on information provided by one or more other software subsystems hosted by the computing platform 102 and (ii) at least one user-defined rule that is to be applied to the user-defined set of information, which includes (a) at least one user-defined condition that is to be evaluated based on the user-defined set of information and (b) at least one corresponding action that is to be carried out automatically by the computing platform if the at least one user-defined condition is satisfied.

At block 504, after retrieving the data representation of the given user-customized workflow from the workflow data store 304, the workflow execution engine 306 may begin executing the given user-customized workflow. The function of executing the given user-customized workflow may take various forms.

In at least some implementations, the workflow execution engine's execution of the given user-customized workflow may involve the workflow execution engine 306 iteratively performing a set of functions in accordance with the given user-customized workflow. For instance, each iteration that is carried out during execution of the given user-customized workflow may involve the workflow execution engine 306 performing a set functions that includes (i) obtaining a given snapshot of the user-defined set of information about the one or more financial accounts associated with the user and then (ii) applying the at least one user-defined rule included in the given user-customized workflow to the given snapshot of the user-defined set of information to determine whether the at least one user-defined condition is satisfied and the at least one corresponding action is to be carried out. In this respect, each iteration that is carried out during execution of the given user-customized workflow may result in one of two determinations: (1) that the at least one user-defined condition is not satisfied and the at least one corresponding action should not be carried out, or (2) that the at least one user-defined condition is satisfied and the at least one corresponding action should be carried out. These functions that are performed during each such iteration may take any of various forms, which may depend on the specifics of the given user-customized workflow and perhaps also on the state of the execution of the given user-customized workflow, among other factors.

For instance, the function of obtaining a given snapshot of the user-defined set of information about the one or more financial accounts associated with the user may take various forms, which may depend on the types of information included in the user-defined set of information for the given user-customized workflow and perhaps also on the state of the execution of the given user-customized workflow. In this respect, as one possible scenario, the user-defined set of information for the given user-customized workflow may include a type of information that is directly available from another software subsystem hosted by the computing platform 102 (including but not limited to a software subsystem that is configured to retrieve information from a third-party platform) and is “dynamic” in the sense that the information is expected to change over time, such as a balance amount for a financial account. In such a scenario, the function of obtaining a given snapshot of information of that type that is carried out during each iteration may involve requesting a new snapshot of the information of that type from the other software subsystem (e.g., by calling the service provided by the software subsystem via its API). For example, if the user-defined set of information comprises a balance amount for a financial account, the function of obtaining a given snapshot of information of that type that is carried out during each iteration may involve requesting and receiving a new snapshot of the account balance information from the third software subsystem 104c that provides the service for determining an account balance.

As another possible scenario, the user-defined set of information for the given user-customized workflow may include a type of information that is directly available from another software subsystem hosted by the computing platform 102 (including but not limited to a software subsystem that is configured to retrieve information from a third-party platform) and is “static” in the sense that the information is not expected to change over time, such as a fixed exchange rate. In such a scenario, the function of obtaining a given snapshot of information of that type that is carried out during a first iteration may involve requesting a new snapshot of the information of that type from the other software subsystem (e.g., by calling the service provided by the software subsystem via its API). After carrying out that first iteration, the new snapshot of the information of that type may be stored for future access in the workflow data store 304 or an in-memory data store associated with the workflow execution engine 306, among other possible storage locations. Then, the function of obtaining a given snapshot of information of that type that is carried out during each subsequent iteration may involve retrieving the stored snapshot of the information of that type from its storage location. For example, if the user-defined set of information includes a fixed exchange rate, the function of obtaining a given snapshot of information of that type that is carried out during a first iteration may involve requesting and receiving a new snapshot of the information of that type from another software subsystem that is configured to provide exchange rate information, and then the function of obtaining a given snapshot of information of that type that is carried out during each subsequent iteration may involve retrieving the previously-received snapshot of the exchange rate information from the workflow data store 304 and/or an in-memory data store associated with the workflow execution engine 306.

As yet another possible scenario, the user-defined set of information for the given user-customized workflow may include a type of information that is not directly available from any other software subsystem hosted by the computing platform 102 but is based on information received from one or more other software subsystem, and is “dynamic” in the sense that the information is expected to change over time. In such a scenario, the function of obtaining a given snapshot of information of that type that is carried out during each iteration may involve (i) requesting and receiving a new snapshot of information from each of one or more other software subsystems (e.g., by calling the service provided by the software subsystem via its API) and then (ii) performing some additional calculation(s) based on the information received from the one or more other software subsystems in order to derive a new snapshot of the information that is to serve as input for the given user-customized workflow. For example, if the user-defined set of information comprises total or net spend for a financial account during a given period of time, the function of obtaining a given snapshot of the information of that type that is carried out during each iteration may involve (i) requesting and receiving a new snapshot of transactions information from at least one other software subsystem (e.g., the “transactions” software subsystem 104b) and then (ii) calculating a new snapshot of the total or net spend for the financial account based on the received transactions information. Many other examples are well.

As still another possible scenario, the user-defined set of information for the given user-customized workflow may include a type of information that is not directly available from any other software subsystem hosted by the computing platform 102 but is based on information from one or more other software subsystem, and is “static” in the sense that the information is not expected to change over time. In such a scenario, the function of obtaining a given snapshot of information of that type that is carried out during the first iteration may involve (i) requesting and receiving a new snapshot of information from each of one or more other software subsystems (e.g., by calling the service provided by the software subsystem via its API) and then (ii) performing some additional calculation(s) based on the information received from the one or more other software subsystems in order to derive a new snapshot of the information that is to serve as input for the given user-customized workflow. After carrying out that first iteration, the new snapshot of the information of that type may be stored for future access in the workflow data store 304 or an in-memory data store associated with the workflow execution engine 306, among other possible storage locations. Then, the function of obtaining a given snapshot of information of that type that is carried out during each subsequent iteration may involve retrieving the stored snapshot of the information of that type from its storage location.

The function of obtaining a given snapshot of the user-defined set of information about the one or more financial accounts associated with the user may take various other forms as well. Further, it should be understood that the user-defined set of information may present two or more of the possible scenarios discussed above, in which case the function of obtaining a given snapshot of the user-defined set of information about the one or more financial accounts associated with the user may involve a combination of the functionality discussed above.

Along similar lines, the function of applying the at least one user-defined rule included in the given user-customized workflow to the given snapshot of the user-defined set of information that is carried out during each iteration may take any of various forms, which may depend on the specifics of the at least one user-defined rule for the given user-customized workflow and perhaps also on the state of the execution of the given user-customized workflow.

The frequency with which the workflow execution engine 306 carries out the iterations during execution of the given user-customized workflow may also take various forms and may be defined in various manners. As one possibility, the workflow execution engine 306 may be configured to carry out the iterations for the given user-customized workflow according to a predefined frequency that serves as a default frequency for execution of all user-customized workflows, which may be set by an administrative user of the computing platform 102 (among other possibilities). In this respect, depending on the implementation, the predefined frequency either could be set to a higher frequency that causes iterations to be carried out in a more continuous manner, or it could be set to a lower frequency that causes iterations to be carried out in a more periodic manner.

As another possibility, the workflow execution engine 306 may be configured to carry out the iterations during execution of the given user-customized workflow according to a frequency that is defined based on certain information in the data representation of the given user-defined workflow. For instance, the given user-customized workflow may include user-defined information indicating the frequency at which a given user-defined rule included in the given user-customized workflow is to be evaluated (e.g., monthly), in which case the workflow execution engine 306 may be configured to carry out the iterations according to that indicated frequency.

As yet another possibility, the workflow execution engine 306 may be configured to carry out the iterations during execution of the given user-customized workflow according to a frequency that is defined based on information that is returned by the other software subsystem(s). For instance, a given other software subsystem may have a particular frequency at which it is configured to return information about a financial account associated with the user, in which case the workflow execution engine 306 may be configured to carry out the iterations according to that software subsystem's particular frequency.

Further, it should be understood that the iterations for the given user-customized workflow need not be carried out according to a fixed rate, and could instead be carried out according to event-based triggers. For instance, in an implementation where the workflow execution engine 306 is configured to carry out the iterations for the given user-customized workflow according to a frequency that is defined based on information returned about occurrences of certain types of transactions, each reporting of a new transaction occurrence may cause a new iteration to be carried out for the user-customized workflow to determine if the at least one user-defined condition is satisfied based on the new transaction occurrence.

As briefly mentioned above, while executing the given user-customized workflow, the workflow execution engine 306 may store status information about the execution of the given user-customized workflow, which may include any of various types of information. As one possibility, the status information may include an indication of how long the given user-customized workflow has been executing, which may be represented in terms of a date/time when execution of the given user-customized workflow began and/or a running amount of execution time, among other examples. As another possibility, the status information may include information about how many iterations of the given user-customized workflow have been carried out during execution, which may include an iteration count and perhaps also date/time information for each iteration. As yet another possibility, the status information may include historical information about how many times each user-defined rule in the given user-customized workflow has been satisfied and other information about each time a user-defined rule was satisfied. For example, for each iteration where a user-defined rule was satisfied, the status information may indicate a date/time and information about the particular snapshot of the user-defined set of information based on which the user-defined rule was determined to be satisfied. As still another possibility, the status information may include information about a current state of each user-defined rule in the given user-customized workflow. For example, the status information may include a respective status indicator for each user-defined rule that indicates whether that user-defined rule was determined to be satisfied or not satisfied in a most-recent iteration of the given user-customized workflow. The status information may include other types of information as well.

Further, the status information may be stored at any storage location that is accessible by the workflow execution engine 306, examples of which may include the workflow data store 304 and/or an in-memory data store associated with the workflow execution engine 306. Other examples are also possible.

Further yet, the workflow execution engine 306 may store the status information at various times. As one example, the workflow execution engine 306 may be configured to store status information after each iteration of the given user-customized workflow, regardless of whether or not any user-defined rule(s) of the given user-customized workflow are determined to be satisfied. As another example, the workflow execution engine 306 may be configured to store status information only after iterations during which a user-defined rule of the given user-customized workflow is determined to be satisfied. The workflow execution engine 306 may be configured to store status information at other times as well.

In practice, the status information stored by the workflow execution engine 306 could then be referenced and used by the workflow execution engine 306 during execution of the given user-customized workflow. For instance, the given user-customized workflow could rely on the status information to determine whether and when to carry out a next iteration of functions in accordance with the given user-customized workflow, among other possibilities. Further, as noted above, the status information stored by the workflow execution engine 306 may later be accessed by the custom workflows software subsystem 300 in response to receiving a user request for information about the status of the given user-customized workflow. The status information stored by the workflow execution engine 306 could be used for other purposes as well.

At block 506, while executing the given user-customized workflow, the workflow execution engine 306 may at some point (e.g., during a given iteration) determine that at least one user-defined condition is satisfied and then responsively cause the at least one corresponding action to be carried out. In line with the discussion above, examples of an action that may be carried out by the computing platform 102 may include, as some non-limiting possibilities, implementing a funds transfer from a first financial account to a second financial account, issuing an alert to be provided to the user, implementing a payment from a financial account to a third party (e.g., a utility provider, a bill payee), and/or generating a report to be provided to the user, among other possibilities. Further, the function of causing the at least one corresponding action to be carried out may take various forms, and at least for some types of actions, may involve making a call to one or more other subsystems of the computing platform 102 that are configured to perform functions for carrying out the action. For example, if the action to be carried out is a funds transfer from a first financial account to a second financial account, the function of carrying out this action may involve sending a request to the first software system 104a to implement the funds transfer. Many other examples are possible as well.

After determining that the at least one user-defined condition is satisfied and responsively causing the at least one corresponding action to be carried out, the workflow execution engine 306 may then proceed in any of various manners with respect to the execution of the given user-customized workflow. As one possibility, the workflow execution engine 306 may be configured to continue executing the given user-customized workflow in the same way that it was previously executing the given user-customized workflow, in which case the workflow execution engine 306 may continue to iteratively carry out a set of functions in accordance with the given user-customized workflow in order to determine whether the at least one user-defined condition is satisfied and the at least one corresponding action is to be carried out again in the future.

As another possibility, after determining that the at least one user-defined condition is satisfied and responsively causing the at least one corresponding action to be carried out, the workflow execution engine 306 may be configured to continue executing the given user-customized workflow, but in a different way than it was previously being executed. For instance, after determining that the at least one user-defined condition is satisfied and responsively causing the at least one corresponding action to be carried out, the workflow execution engine 306 may be configured to change the frequency with which the iterations are carried out during execution of the given user-customized workflow from an original frequency to a reduced frequency such that the iterations are carried out less frequently while the at least one condition is in the “satisfied” state, and may then return to the original frequency after determining that the at least one condition is no longer in the “satisfied” state. For instance, if the given user-customized workflow includes a user-defined rule that requires the workflow execution engine 306 to determine whether an account balance is below a threshold and then issue an alert if the balance is below the threshold, the workflow execution engine 306 may perform iterations of the given user-customized workflow at an original frequency that is more continuous in nature (e.g., every 5 minutes). During an iteration where the workflow execution engine 306 determines that the account balance is below the threshold and the user-defined rule is thus satisfied, the workflow execution engine 306 may issue an alert and then perform subsequent iterations at a reduced frequency (e.g., once per day) until it determines that the rule is no longer in the satisfied state (e.g., the account balance is no longer below the threshold). Thereafter, the workflow execution engine 306 may resume performing iterations at the original frequency. Many other examples are possible as well.

As yet another possibility, after determining that the at least one user-defined condition is satisfied and responsively causing the at least one corresponding action to be carried out, the workflow execution engine 306 may be configured to suspend execution of the given user-customized workflow until it detects some indication that execution of the given user-customized workflow is to be resumed. Such an indication may take various forms. As one example, the workflow execution engine 306 may detect a user request to resume execution of the given user-customized workflow. As another example, the workflow execution engine 306 may detect that the user-defined rule is no longer in the satisfied state. In this respect, the workflow execution engine 306 may detect that the user-defined rule is no longer in the satisfied state in various ways, including by iteratively evaluating whether the at least one user-defined condition is still satisfied (e.g., based on new snapshots of the user-defined set of information), among other examples. The indication that execution of the given user-customized workflow is to be resumed may take other forms as well.

After determining that the at least one user-defined condition is satisfied and responsively causing the at least one corresponding action to be carried out, the workflow execution engine 306 may proceed in other manners with respect to the execution of the given user-customized workflow as well.

Advantageously, this functionality for executing a user-customized workflow in an iterative manner alleviates any burden from a user to repeatedly prompt the computing platform 102 to perform the workflow, among various other advantages of the disclosed technology.

The process that may be carried out by the custom workflows software subsystem disclosed herein in order to execute a user-customized workflow may take various other forms as well.

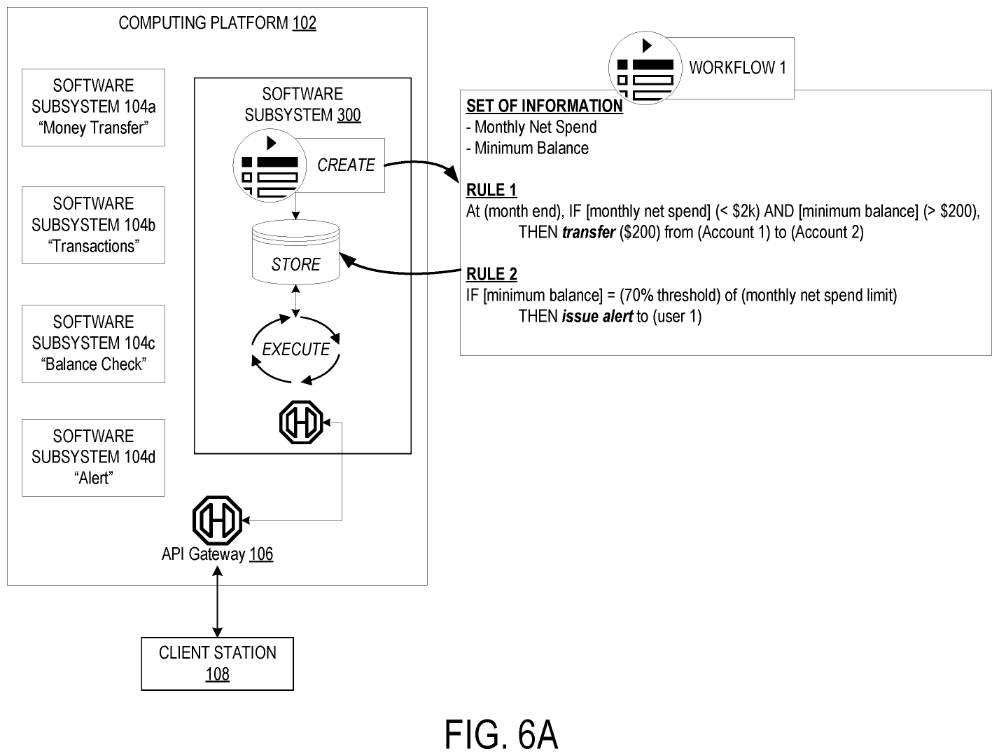

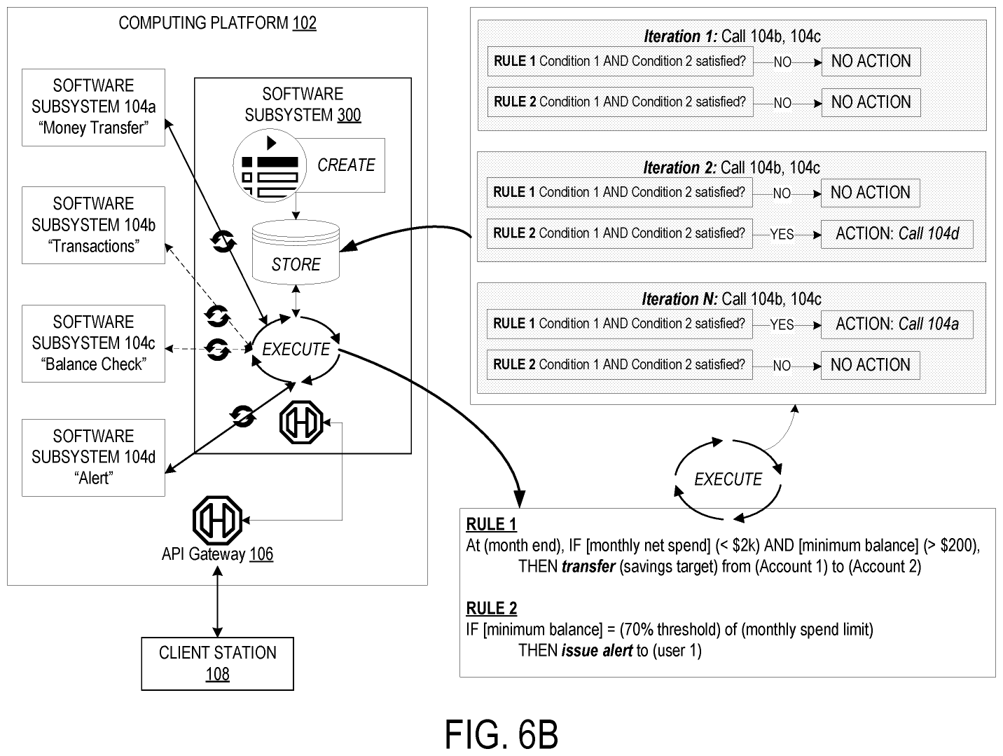

Turning now to FIG. 6A-6B, an illustrative example of executing a given user-customized workflow is shown. The example shown in FIGS. 6A-6B depicts an implementation where a user may have built a user-customized workflow by using a client station 108 to access the service provided by the custom workflows software subsystem 300 hosted by the computing platform 102, and how the custom workflows software subsystem 300 may execute that workflow. As shown in FIG. 6A, during the build process, the user may have provided inputs in the manner described above to define a new user-customized workflow titled “Workflow 1,” which may include a user-defined set of information that is to serve as input to the user-customized workflow and at least two user-defined rules. A representation of the data defining Workflow 1 may then be stored by the custom workflows software subsystem 300 in the workflow data store 304.

As depicted in FIG. 6A, the user-defined set of information included in the Workflow 1 comprises (i) information about transactions within a given financial account (e.g., net spend) and (ii) information about an account balance of the given financial account. Further, the Workflow 1 may comprise two user-defined rules, Rule 1 and Rule 2, that each have one condition comprising two predicates and one corresponding action that is to be carried out by the computing platform 102 if the condition is determined to be satisfied. Although not shown in FIG. 6A, the Workflow 1 may also include configuration information that further defines the user-defined set of information, the user-defined conditions, and/or the corresponding actions. Such configuration information may include (i) a given period of time (e.g., one month), (ii) a maximum monthly net spend limit (e.g., $2,000), (iii) a minimum balance (e.g., $200), (iv) a target savings amount (e.g., $200), (v) respective account identifiers for two financial accounts associated with the user (e.g., Account 1 and Account 2), (vi) a threshold percentage (e.g., 70%), and (vii) contact information for the user (e.g., user 1). Together, the user-defined set of information, along with the conditions and corresponding action for each of Rule 1 and Rule 2, make up the Workflow 1.

As shown in FIG. 6A, Rule 1 comprises a conditional statement indicating that at the end of any given month, IF a monthly net spend amount for a given financial account is less than $2,000 and the financial account has a minimum balance greater than $200, THEN an amount of $200 is to be transferred from a first account to a second account. Further, Rule 2 comprises a conditional statement indicating that if the minimum balance of the financial account reaches a 70% threshold of a monthly net spend limit, THEN an alert is to be generated and issued to the user. In each of the conditional statements for Rule 1 and Rule 2 shown in FIG. 6A, the user-defined information that serves as input information for the Workflow 1 is depicted within a set of brackets, and the configuration information that further defines the user-defined information is depicted within a set of parenthesis.

After the Workflow 1 is stored in the workflow data store 304, the workflow execution engine 306 may retrieve and begin to execute the Workflow 1 by iteratively performing functions in accordance with the Workflow 1, as shown in FIG. 6B. During each iteration that is carried out while executing the Workflow 1, the workflow execution engine 306 may obtain a given snapshot of information about a financial account as defined in Workflow 1. As described above, depending on the type of information included in the user-defined set of information for the Workflow 1, obtaining the given snapshot of information may take various forms, one example of which may involve requesting that information from one or more other software subsystems of the computing platform 102. In the example of FIG. 6B, based on the user-defined set of information and configuration information included in Workflow 1 (e.g., monthly net spend and minimum account balance for Account 1), the workflow execution engine 306 may obtain, during Iteration 1, a first snapshot of information about Account 1 by requesting that information from other software subsystems of the computing platform, such as the software subsystems 104b and 104c. In particular, the workflow execution engine 306 may request transactions information (e.g., monthly net spend) from the “transactions” software subsystem 104b and account balance information from the “balance check” software subsystem 104c. The workflow execution engine 306 may then apply Rules 1 and 2 to the information returned by the software subsystems 104b and 104c to determine if any of the Rules 1 or 2 is satisfied. As shown in FIG. 6B, during Iteration 1, the workflow execution engine 306 may determine that neither rule is satisfied, and therefore no action corresponding action is to be performed.

After completing Iteration 1, the workflow execution engine 306 may begin carrying out Iteration 2. As discussed above, the manner in which snapshots of information are obtained may depend on whether the type of information included the user-defined set of information is “dynamic” or “static.” For example, information about a balance amount is expected to change over time and is thus dynamic. Therefore, in the example of FIG. 6B, for each iteration that is carried out during execution of the Workflow 1, the workflow execution engine 306 may obtain a new snapshot of information. Thus, during Iteration 2, the workflow execution engine 306 may obtain a second snapshot of information about Account 1 by again requesting that information from software subsystems 104b and 104c and then applying Rules 1 and 2 to the obtained information. As shown in FIG. 6B, during Iteration 2, the workflow execution engine 306 may determine that (i) Rule 1 is not satisfied and a corresponding action is not to be carried out and (ii) Rule 2 is satisfied and a corresponding action is to be carried out. As previously mentioned, facilitating carrying out a corresponding action may involve the workflow execution engine 306 interacting with one or more other software subsystems to carry out the corresponding action. During Iteration 2, the workflow execution engine 306 may determine that the corresponding action for Rule 2 (issuing an alert) requires interaction with another software subsystem. Therefore, as shown in FIG. 6B, the workflow execution engine 306 may communicate with the software subsystem 104d to facilitate carrying out the corresponding action for Rule 2 of generating and issuing an alert to the user. The workflow execution engine 306 may then continue to iteratively execute the Workflow 1 and carry out the corresponding action for Rule 1 and/or Rule 2 when it determines that the conditions for Rule 1 and/or Rule 2 have been satisfied.

For instance, during some later iteration such as “Iteration N” shown in FIG. 6B, based on a respective snapshot of information obtained by the software subsystems 104b and 104c, the workflow execution engine 306 may determine that (i) Rule 1 is satisfied and the corresponding action for Rule 1 is to be carried out and (ii) Rule 2 is not satisfied and the corresponding action for Rule 2 is not to be carried out. Further, the workflow execution engine 306 may determine that carrying out the corresponding action for Rule 1 involves interacting with another software subsystem of the computing platform 102. Therefore, the workflow execution engine 306 may then interact with the software subsystem 104a to facilitate a transfer of funds from Account 1 to Account 2 as dictated by Rule 1.

Thereafter, the workflow execution engine 306 may continue to iteratively execute the Workflow 1 and for each determination that either or both of Rule 1 or Rule 2 is satisfied, responsively carry out the corresponding action for the rule. Further, the workflow execution engine 306 may store status information about the execution of the Workflow 1 in the workflow data store 304 as described above.

In the ways described herein, the disclosed software technology enables creation and execution of user-customized workflows that automate actions related to one or more financial accounts associated with a user by applying user-defined rules to user-defined sets of information about the one or more financial accounts, thereby allowing customers of a financial institution to interact with their financial accounts in a more targeted and personalized way.

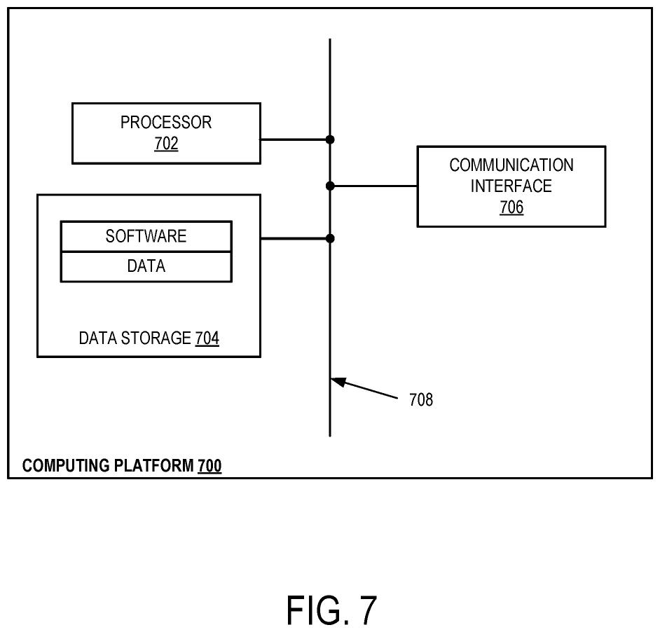

Turning now to FIG. 7, a simplified block diagram is provided to illustrate some structural components that may be included in an example computing platform 700, which may be configured to host and execute the new software technology disclosed herein, such as the custom workflows software subsystem 300. At a high level, the computing platform 700 may generally comprise any one or more computing systems that collectively include at least a processor 702, data storage 704, and a communication interface 706, all of which may be communicatively linked by a communication link 708 that may take the form of a system bus, a communication network such as a public, private, or hybrid cloud, or some other connection mechanism. Each of these components may take various forms.

Processor 702 may comprise one or more processing components, such as general-purpose processors (e.g., a single- or multi-core a central processing unit (CPU)), special-purpose processors (e.g., a graphics processing unit (GPU), application-specific integrated circuit, or digital-signal processor), programmable logic devices (e.g., a field programmable gate array), controllers (e.g., microcontrollers), and/or any other processor components now known or later developed. In line with the discussion above, it should also be understood that processor 702 could comprise processing components that are distributed across a plurality of physical computing devices connected via a network, such as a computing cluster of a public, private, or hybrid cloud.

In turn, data storage 704 may comprise one or more non-transitory computer-readable storage mediums that are collectively configured to store (i) program instructions that are executable by processor 702 such that computing platform 700 is configured to perform certain functions in connection with providing services for interacting with financial accounts, and (ii) data that may be received, derived, or otherwise stored, for example, in one or more databases, file systems, repositories, or the like, by computing platform 700, in connection with providing services for interacting with financial accounts. In this respect, the one or more non-transitory computer-readable storage mediums of data storage 704 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 704 may comprise computer-readable storage mediums that are distributed across a plurality of physical computing devices connected via a network, such as a storage cluster of a public, private, or hybrid cloud. Data storage 704 may take other forms and/or store data in other manners as well.

Communication interface 706 may be configured to facilitate wireless and/or wired communication with client stations (e.g., one or more client stations 108 of FIG. 1) and/or third-party computing platforms. Additionally, in an implementation where the computing platform 700 comprises a plurality of physical computing devices connected via a network, communication interface 706 may be configured to facilitate wireless and/or wired communication between these physical computing devices (e.g., between computing and storage clusters in a cloud network). As such, communication interface 706 may take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for wireless communication (e.g., Wi-Fi communication, cellular communication, short-range wireless protocols, etc.) and/or wired communication. Other configurations are possible as well.

Although not shown, the computing platform 700 may additionally include or have an interface for connecting to one or more user-interface components that facilitate user interaction with the computing platform 700, such as a keyboard, a mouse, a trackpad, a display screen, a touch-sensitive interface, a stylus, a virtual-reality headset, and/or one or more speaker components, among other possibilities.

It should be understood that the computing platform 700 is one example of a computing platform that may be used with the embodiments described herein. Numerous other arrangements are possible and contemplated herein. For instance, in other embodiments, the computing platform 700 may include additional components not pictured and/or more or fewer of the pictured components.

Example embodiments of the disclosed innovations have been described above. Those skilled in the art will understand, however, that changes and modifications may be made to the embodiments described without departing from the true scope and spirit of the present invention, which will be defined by the claims. For instance, those in the art will understand that the disclosed technology for creating and executing user-customized workflows may be implemented in areas other than for purposes of interacting with financial accounts.

Further, to the extent that examples described herein involve operations performed or initiated by actors, such as “humans,” “operators,” “users” or other entities, this is for purposes of example and explanation only. The claims should not be construed as requiring action by such actors unless explicitly recited in the claim language.

1. A computing platform comprising:
at least one processor;
at least one non-transitory computer-readable medium; and
program instructions stored on the at least one non-transitory computer-readable medium that are executable by the at least one processor such that the computing platform is configured to:
retrieve, from a workflow data store, a given workflow that has been previously built by a user and comprises: (i) a user-defined set of information about one or more financial accounts associated with the user that is to be iteratively obtained and used as input for the given workflow, and (ii) at least one user-defined rule that is to be iteratively applied to the user-defined set of information, wherein the at least one user-defined rule comprises (a) at least one condition that is to be evaluated based on the user-defined set of information and (b) at least one action that is to be carried out automatically by the computing platform when the at least one condition is determined to be satisfied;
begin to execute the given workflow, wherein, while executing the given workflow, the computing platform functions to iteratively: (i) obtain a given snapshot of the user-defined set of information about the one or more financial accounts associated with the user and (ii) apply the at least one user-defined rule to the given snapshot of the user-defined set of information to determine if the at least one condition is satisfied;
while executing the given workflow, determine that the at least one condition is satisfied; and
in response to determining that the at least one condition is satisfied, cause the at least one action to be carried out.

2. The computing platform of claim 1, wherein the program instructions stored on the at least one non-transitory computer-readable medium that are executable by the at least one processor such that the computing platform is configured to iteratively obtain the given snapshot of the user-defined set of information about the one or more financial accounts associated with the user comprise program instructions that are executable by the at least one processor such that the computing platform is configured to:
iteratively obtain a given snapshot of information from one or more other network-accessible services hosted by the computing platform.

3. The computing platform of claim 2, wherein the program instructions stored on the at least one non-transitory computer-readable medium that are executable by the at least one processor such that the computing platform is configured to iteratively obtain the given snapshot of the user-defined set of information about the one or more financial accounts associated with the user further comprise program instructions that are executable by the at least one processor such that the computing platform is configured to:
iteratively derive the given snapshot of the user-defined set of information about the one or more financial accounts associated with the user based at least in part on the given snapshot of information obtained from the one or more other network-accessible services hosted by the computing platform.

4. The computing platform of claim 1, wherein the program instructions stored on the at least one non-transitory computer-readable medium that are executable by the at least one processor such that the computing platform is configured to cause the at least one action to be carried out comprise program instructions that are executable by the at least one processor such that the computing platform is configured to:
cause at least one other network-accessible service hosted by the computing platform to carry out the at least one action.

5. The computing platform of claim 1, wherein the user-defined set of information about the one or more financial accounts associated with the user includes at least one of (i) an account balance, (ii) one or more transactions, or (iii) one or more due payments.

6. The computing platform of claim 1, wherein the at least one condition comprises at least one of (i) a threshold amount of money, (ii) a minimum balance amount, or (iii) an occurrence of a given type of transaction.

7. The computing platform of claim 1, wherein the at least one action comprises at least one of (i) a funds transfer type of action, (ii) an alert type of action, or (iii) a payment type of action.

8. The computing platform of claim 1, wherein the given workflow comprises multiple user-defined rules that are to be applied to the user-defined set of information, and wherein each of the multiple user-defined rules comprises (a) one respective condition that is to be evaluated based on at least a portion of the user-defined set of information and (b) one respective action that is to be carried out automatically by the computing platform when the one respective condition is determined to be satisfied.

9. The computing platform of claim 1, wherein, while executing the given workflow, the computing platform functions to iteratively obtain the given snapshot of the user-defined set of information and apply the at least one user-defined rule to the given snapshot in accordance with an iteration frequency.

10. The computing platform of claim 9, wherein the iteration frequency is defined based on configuration information included as part of the given workflow.

11. A non-transitory computer-readable medium, wherein the non-transitory computer-readable medium is provisioned with program instructions that, when executed by at least one processor, cause a computing platform to:
retrieve, from a workflow data store, a given workflow that has been previously built by a user and comprises: (i) a user-defined set of information about one or more financial accounts associated with the user that is to be iteratively obtained and used as input for the given workflow, and (ii) at least one user-defined rule that is to be iteratively applied to the user-defined set of information, wherein the at least one user-defined rule comprises (a) at least one condition that is to be evaluated based on the user-defined set of information and (b) at least one action that is to be carried out automatically by the computing platform when the at least one condition is determined to be satisfied;
begin to execute the given workflow, wherein, while executing the given workflow, the computing platform functions to iteratively: (i) obtain a given snapshot of the user-defined set of information about the one or more financial accounts associated with the user and (ii) apply the at least one user-defined rule to the given snapshot of the user-defined set of information to determine if the at least one condition is satisfied;
while executing the given workflow, determine that the at least one condition is satisfied; and
in response to determining that the at least one condition is satisfied, cause the at least one action to be carried out.

12. The non-transitory computer-readable medium of claim 11, wherein the program instructions that, when executed by at least one processor, cause the computing platform to iteratively obtain the given snapshot of the user-defined set of information about the one or more financial accounts associated with the user comprise program instructions that, when executed by at least one processor, cause the computing platform to:
iteratively obtain a given snapshot of information from one or more other network-accessible services hosted by the computing platform.

13. The non-transitory computer-readable medium of claim 12, wherein the program instructions that, when executed by at least one processor, cause the computing platform to iteratively obtain the given snapshot of the user-defined set of information about the one or more financial accounts associated with the user further comprise program instructions that, when executed by at least one processor, cause the computing platform to:
iteratively derive the given snapshot of the user-defined set of information about the one or more financial accounts associated with the user based at least in part on the given snapshot of information obtained from the one or more other network-accessible services hosted by the computing platform.

14. The non-transitory computer-readable medium of claim 11, wherein the program instructions that, when executed by at least one processor, cause the computing platform to cause the at least one action to be carried out comprise program instructions that, when executed by at least one processor, cause the computing platform to:
cause at least one other network-accessible service hosted by the computing platform to carry out the at least one action.

15. The non-transitory computer-readable medium of claim 11, wherein the user-defined set of information about the one or more financial accounts associated with the user includes at least one of (i) an account balance, (ii) one or more transactions, or (iii) one or more due payments.

16. The non-transitory computer-readable medium of claim 11, wherein the at least one condition comprises at least one of (i) a threshold amount of money, (ii) a minimum balance amount, or (iii) an occurrence of a given type of transaction.

17. The non-transitory computer-readable medium of claim 11, wherein the at least one action comprises at least one of (i) a funds transfer type of action, (ii) an alert type of action, or (iii) a payment type of action.

18. The non-transitory computer-readable medium of claim 11, wherein the given workflow comprises multiple user-defined rules that are to be applied to the user-defined set of information, and wherein each of the multiple user-defined rules comprises (a) one respective condition that is to be evaluated based on at least a portion of the user-defined set of information and (b) one respective action that is to be carried out automatically by the computing platform when the one respective condition is determined to be satisfied.

19. The non-transitory computer-readable medium of claim 11, wherein, while executing the given workflow, the computing platform functions to iteratively obtain the given snapshot of the user-defined set of information and apply the at least one user-defined rule to the given snapshot in accordance with an iteration frequency.

20. A method carried out by a computing platform, the method comprising:
retrieving, from a workflow data store, a given workflow that has been previously built by a user and comprises: (i) a user-defined set of information about one or more financial accounts associated with the user that is to be iteratively obtained and used as input for the given workflow, and (ii) at least one user-defined rule that is to be iteratively applied to the user-defined set of information, wherein the at least one user-defined rule comprises (a) at least one condition that is to be evaluated based on the user-defined set of information and (b) at least one action that is to be carried out automatically by the computing platform when the at least one condition is determined to be satisfied;
beginning to execute the given workflow, wherein, while executing the given workflow, the computing platform functions to iteratively: (i) obtain a given snapshot of the user-defined set of information about the one or more financial accounts associated with the user and (ii) apply the at least one user-defined rule to the given snapshot of the user-defined set of information to determine if the at least one condition is satisfied;
while executing the given workflow, determining that the at least one condition is satisfied; and
in response to determining that the at least one condition is satisfied, causing the at least one action to be carried out.
